(19) United States
(12) Patent Application Publication
(10) Pub. No.: US 2008/0196522 A1
(43) Pub. Date: Aug. 21, 2008

(54) Device for Coupling a Vacuum Pump with a Camshaft Comprising Means Supplying Lubricating Fluid

(75) Inventors: Guy Eberhardt, Clichy Sous Bois (FR); Jean Claude Kuhn, Les Clayes Sous Bois (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., BOULOGNE BILLANCOURT (FR)

(21) Appl. No.: 11/915,587

(22) PCT Filed: May 24, 2006
(86) PCT No.: PCT/FR2006/050474

§ 371 Date: Nov. 27, 2007

(30) Foreign Application Priority Data
Jun. 3, 2005 (FR) 0505613

(51) Int. Cl. F16H 21/14

(52) U.S. Cl. 74/63

(57) ABSTRACT

The invention concerns a device for coupling a vacuum pump (3) with a camshaft (1) of a motor vehicle internal combustion engine, comprising an end piece (6) provided with first and second coaxial portions (7, 9) delimiting an annular space wherein is mounted one of the ends of the camshaft, at least one of said portions being adapted to transmit a torque to the camshaft, and means for transmitting said torque to the pump. Said second axial portion (9) is provided with a housing (18) extending along said axis and designed to receive a means for drawing from the pump adapted to draw a lubricating fluid directed into the camshaft so as to provide a fluid communication between the camshaft and the pump.

The present invention relates to a device for coupling a vacuum pump to a camshaft of an internal combustion engine for a motor vehicle with a view to driving the rotation of said vacuum pump.

An internal combustion engine camshaft may be subjected to resistive torques of greater or lesser magnitude as the engine is running. A coupling is generally needed to transmit the engine torque supplied by a crankshaft of the engine efficiently to the camshaft. This coupling, or another coupling, can also be used to operate a pump, particularly a vacuum pump.

This is because in a motor vehicle comprising an internal combustion engine of the diesel type, brake boosting is performed by a servobrake connected to a vacuum pump driven off the engine, for example via a coupling device fixed to one end of the engine camshaft.

In this respect, reference may be made to document WO 2004/057163, which describes the transmission of torque from the camshaft of an engine to a vacuum pump via such a coupling device. Said device comprises a body inside which there is a stepped bore that accommodates the end of the camshaft and accepts a screw able to bear against a portion of said body so as to secure the device to the camshaft. The body also comprises radial slots collaborating with tenons belonging to the vacuum pump in order to transmit torque to said pump.

Furthermore, the bore of the body is shaped in such a way as to allow fluidic communication between the camshaft and the vacuum pump so as to lubricate the pump with a lubricant used for the engine.

Aside from the fact that this device is difficult to assemble, it comprises a body of relatively complicated and expensive shape, which may prove incompatible with mass production.

It is therefore an object of the present invention to remedy these disadvantages by proposing a device for coupling a vacuum pump to a camshaft of an internal combustion engine that is particularly easy to assemble, is economical and is reliable.

It is another object of the present invention to provide a device for coupling a vacuum pump to a camshaft that can be coupled to said camshaft once the timing of this shaft has been set.

To these ends, the subject of the invention is a device for coupling a vacuum pump to a tubular camshaft of an internal combustion engine for a motor vehicle, comprising an end-piece provided with coaxial first and second portions delimiting an annular space inside which one of the ends of the camshaft is mounted, at least one of said portions being able to transmit torque to the camshaft, and with means for transmitting said torque to the pump.

Said second axial portion is equipped with a housing extending along said axis and intended to receive a pick-up means of the pump, able to pick up a lubricant carried along inside the camshaft so as to provide fluidic communication between the camshaft and the pump.

The device has the advantage that it has just one end-piece used not only to transmit torque to the camshaft and to the vacuum pump, but also to supply said pump with fluid via the camshaft, and that it is able to do so in a particularly simple and economical way, while at the same time being free of costly and complex assembly constraints.

As a preference, the first portion comprises a bore inside which the end of the camshaft is pushed.

Advantageously, the first and second portions are joined together by a radical end wall.

An arrangement such as this makes it possible to obtain a leaktight end-piece that appreciably restricts any possible leaks to the outside of the lubricant present within the camshaft.

In one particularly advantageous embodiment, the first and second portions and the end wall are made as one, making it possible to obtain a device that is economical, easy to assemble and easy to transport.

The annular space may have a radial dimension appreciably greater than the thickness of the camshaft.

As a preference, the end-piece further comprises at least one flange-forming radial portion extending outwards from the first portion and able to receive a camshaft drive torque.

Advantageously, the means for transmitting torque to the pump comprise a radial slot formed at the end-piece.

The device further comprises a fixed flange fixed to the camshaft, a twinning pinion connected to said fixed end flange, a sprocket wheel fixed to said twinning pinion, the end-piece being mounted directly or indirectly on the sprocket wheel.

As a preference, the housing of the second axial portion consists of a bore.

The present invention will be better understood from reading the detailed description of one embodiment taken by way of nonlimiting example and illustrated by the attached drawings, in which:

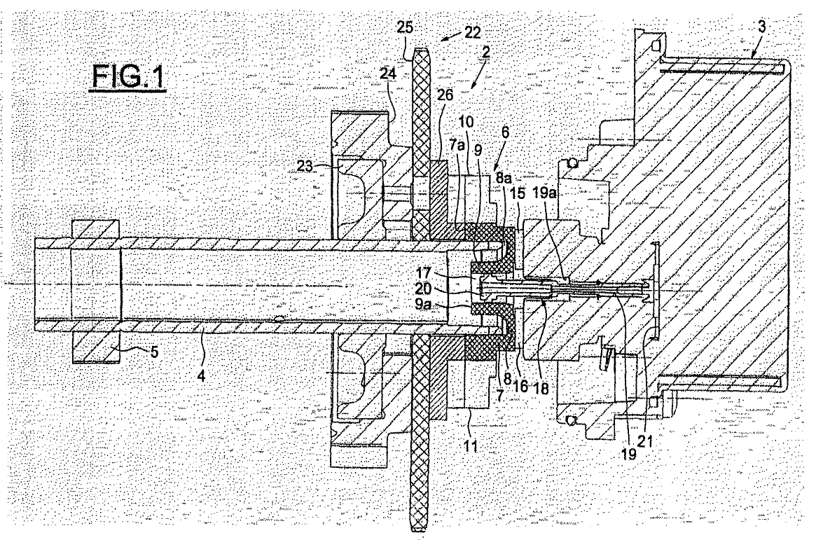

FIG. 1 is a schematic sectioned view of a coupling device according to the invention mounted on a camshaft and driving a vacuum pump;

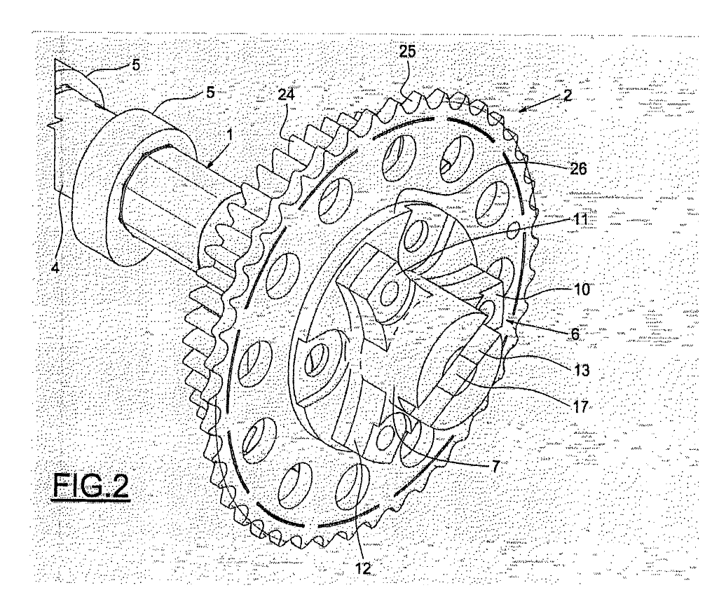

FIG. 2 is a perspective view of the device of FIG. 1; and

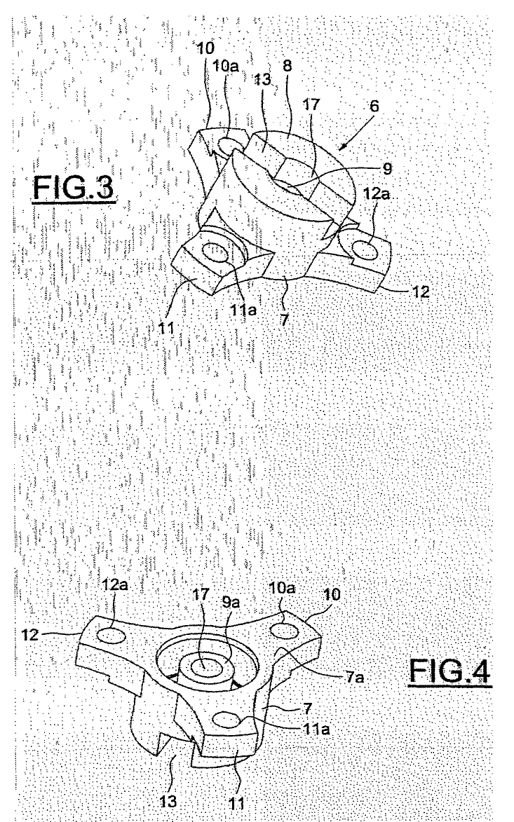

FIGS. 3 and 4 are perspective views of an end-piece of the device of FIG. 1.

FIGS. 1 and 2 depict a camshaft 1 provided with a device according to the invention, denoted by the general numerical reference 2, and allowing a vacuum pump 3 to be coupled to said shaft 1.

The camshaft 1 has been illustrated partially. However, it will be noted that it essentially consists of a tube 4 externally bearing a set of cams 5, as is known per se.

The coupling device 2 comprises an end-piece 6 made as a single piece and provided with an annular first portion 7, forming a sleeve coaxial with the shaft 1, and secured to one of the ends of the tube 4. The first portion 7 is extended inwards, axially on the same side as the vacuum pump 3, by a radial end wall 8 which is itself extended axially, on the opposite side to said pump 3, by an axial second portion 9 that is essentially cylindrical. The second portion 9 here comprises a transverse radial surface 9a which is substantially axially offset with respect to a transverse radial surface 7a of the first portion 7, in the direction of the radial wall 8.

The first and second portions 7, 9 are coaxial and delimit an annular space 8a inside which the end of the tube 4 is mounted. The annular space 8a here has a radial dimension appreciably greater than the thickness of the camshaft 1, so as to leave a small radial space remaining between a bore of said shaft and the second portion 9 to make it easier to push the first portion 7 onto the shaft 1 when fitting the end-piece 6.

As is more visibly illustrated in FIGS. 3 and 4, the end-piece 6 also comprises flange-forming radial portions, here, three in number and referenced 10 to 12, extending radially outwards from the first portion 7 and able to receive engine torque. The flanges 10 to 12 are uniformly distributed here about the circumference of the first portion 7 and comprise respective bores 10a to 12a for the passage of fixing screws (not depicted) for transmitting the engine torque.

As far as the first portion 7 is concerned, it is intended to transmit said engine torque received via the flanges 10 to 12 to the vacuum pump 3. The torque that can be transmitted is dependent upon the length of the first portion 7, upon its thickness and upon its rupture strength. In order to transmit this torque to the vacuum pump 3, the end-piece 6 comprises a radial slot 13 made at the radial end wall 8 and collaborating with tenons 15 and 16 belonging to the pump 3, of a complementary shape, positioned at one of its axial ends.

Of course, it is also conceivable to provide other means of transmitting engine torque to the pump 3. However, the use of such tenons 15, 16 and slot 13 is particularly simple and effective.

The end-piece 6 also comprises a housing 17, here produced in the form of a bore passing right through the second portion 9, and opening onto a transverse surface of the radial wall 8. The housing 17 is coaxial with the camshaft 1.

To permit fluidic communication between the camshaft 1 inside which a lubricant is carried, and the vacuum pump 3, a pick-up means 18 of said pump is mounted inside said housing 17.

The pick-up means 18 comprises a tubular pipette 19 coaxial with the shaft 1 and mounted partially inside a bore 19a of the vacuum pump 3. The pipette 19 projects relative to an end surface of said pump 3 and, near its axial end, has an annular lip 20 in contact with the housing 17 so as to make a good seal between the end-piece 6 and said pipette 19 in order to appreciably limit the risk of lubricant leaking to the outside. The pipette 19 thus allows said feed galleries 21 of the pump 3 to be supplied with lubricant in order to lubricate this pump.

The end-piece 6 is thus not only intended to receive engine torque and transmit it to the camshaft 1 and pump 3, but is also able to supply said pump 3 with lubricant from the fluid flowing through the camshaft 1.

In order to receive engine torque, the coupling device 2 also comprises a drive member 22, here provided with a fixed flange 23 fixed to the camshaft 1 near its axial end, with a twinning pinion 24 positioned on said fixed flange 23, with a sprocket wheel 25 attached to said twinning pinion, axially on the opposite side to the fixed flange 23, and with a fastening spacer piece 26 mounted axially between the sprocket wheel 25 and the transverse radial surface 9a of the end-piece 6.

As an alternative, it is also conceivable to provide a single component combining the sprocket wheel 25 and the spacer piece 26. However, the spacer piece 26 makes it possible to use existing pinions 24 and sprockets 25.

When assembling the coupling device 2, a first step is to attach the fixed flange 23 to the camshaft 1, for example by welding, shrink-fitting or alternatively by bonding. Next, the twinning pinion 24, the sprocket wheel 25 and the spacer piece 26 are fitted onto the fixed flange 23 using fastening screws (not depicted), without tightening said screws. The engine crankshaft and the camshaft 1 are then prevented from turning and a timing chain mounted on the sprocket wheel 25 is tensioned. The pinion 24 and sprocket 25 may pivot slightly relative to the camshaft 1 by virtue of oblong holes (not depicted) made in said pinion and sprocket, according to the tension in said chain. The pinion 24, the sprocket 25 and the spacer piece 26 are then immobilized on the fixed flange 23 using the fixing screws, and the timing between the crankshaft and the camshaft 1 is thus particularly accurate.

Once the drive member 22 has thus been mounted on the camshaft 1, the end-piece 6 is fixed to the spacer piece 26 at the end of the shaft 1 making it possible, and doing so in a particularly economical way, for the engine torque to be transmitted to the camshaft 1 and to the pump 3 and for said pump to be supplied with lubricant using the same fluid as used for said camshaft.

1-9. (canceled)

10. A device for coupling a vacuum pump to a camshaft of an internal combustion engine for a motor vehicle, comprising:
an end-piece including coaxial first and second portions delimiting an annular space inside which one of the ends of the camshaft is mounted, at least one of the first and second portions configured to transmit torque to the camshaft; and
means for transmitting the torque to the pump;
the second axial portion including a housing extending along the axis and configured to receive a pick-up means of the pump, to pick up a lubricant carried along inside the camshaft to provide fluidic communication between the camshaft and the pump.

11. The device as claimed in claim 10, wherein the first portion comprises a bore inside which the end of the camshaft is pushed.

12. The device as claimed in claim 10, wherein the first and second portions are joined together by a radical end wall.

13. The device as claimed in claim 12, wherein the first and second portions and the end wall are made as one.

14. The device as claimed in claim 10, wherein the annular space has a radial dimension appreciably greater than the thickness of the camshaft.

15. The device as claimed in claim 10, wherein the end-piece further comprises at least one flange-forming radial portion extending outwards from the first portion and configured to receive a camshaft drive torque.

16. The device as claimed in claim 10, wherein the means for transmitting torque to the pump comprises a radial slot formed at the end-piece.

17. The device as claimed in claim 10, further comprising:
a fixed flange fixed to the camshaft;
a twinning pinion connected to the end flange; and
a sprocket wheel fixed to the twinning pinion, the end-piece being mounted directly or indirectly on the sprocket wheel.

18. The device as claimed in claim 10, wherein the housing includes a bore.
